(19) United States
(12) Patent Application Publication
(10) Pub. No.: US 2012/0127288 A1
(43) Pub. Date: May 24, 2012

(54) 2D-to-3D DELAY COMPENSATION SYSTEM AND METHOD THEREOF

(75) Inventors: Shin-Shiuan CHENG, TAINAN (TW); Shu-Ming LIU, TAINAN (TW); Hung-Chia LEE, TAINAN (TW)

(73) Assignee: HIMAX MEDIA SOLUTIONS, INC., TAINAN (TW)

(21) Appl. No.: 12/954,538

(22) Filed: Nov. 24, 2010

(51) Int. Cl. H04N 13/04

(52) U.S. Cl. 348/56; 348/E13.04

(57) ABSTRACT

A 2D-to-3D delay compensation method for making a pair of shutter glasses be synchronization with a display device's playback of a video source is disclosed. The display device is coupled with a 2D-to-3D conversion box. The method includes the following steps: firstly, the 2D-to-3D conversion box sends out a calibration pattern to the display device. Then, a shutter control signal is sent out after waiting a delay time to switch on and off the left and right lenses of the pair of shutter glasses. Subsequently, the calibration pattern is detected. Finally, determine whether the delay time must be adjusted or not according to the detecting result.

### BACKGROUND OF THE INVENTION

1. Field of the Invention

The present invention generally relates to delay compensation system, and more particularly to a 2D-to-3D delay compensation system and method thereof.

2. Description of Related Art

Formerly the video displayed in a panel display device such as liquid crystal display (LCD) TV is two-dimensional (2D) image source. In the wake of developments in displaying technology, the applications of displaying three-dimensional (3D) visual effect have increased with each passing day, such as 3D films, 3D games, and product displaying, etc. It results that the 3D imaging system becomes more practical and popular.

Besides using 3D display to achieve 3D imaging effect, the displays with general functions can be connected with a 2-to-3D conversion box to generate 3D visual effect as well. Please refer to FIG. 1, which shows a block diagram of a conventional 2D-to-3D imaging system 1. The 2D-to-3D imaging system 1, which comprises a 2D-to-3D conversion box 13 and a pair of 2D-to-3D shutter glasses 15, is tied in with a display device 11. The 2D-to-3D conversion box 13 is connected with the display device 11, and is configured to convert the input 2D video source to a converted 3D output format. The converted 3D output format frames then may be transmitted to the display device 11 to display. Specifically, it can be implemented by the Depth-Image-Based Rendering (DIBR) technique in the 2D-to-3D conversion box 13, for example, disclosed in “A 3D-TV Approach Using Depth-Image-Based Rendering (DIBR)” by Christoph Fehn, the disclosure of which is hereby incorporated by reference, to generate (or synthesize) a left (L) image and a right (R) image from the original 2D video source, which are then displayed and viewed by the viewer.

The pair of shutter glasses 15 comprises a left (L) lens 151 and a right (R) lens 153. When the 2D-to-3D conversion box 13 outputs the left and right images, it may send out a synchronization signal to the pair of shutter glasses 15 for it to switch on and off its right and left lens 153, 151, which further controls the left and right images to only pass through the left and right lenses 151, 153 respectively. Therefore, when the viewer wears the pair of shutter glasses 15 to view the left and right images displayed by the display device 11, the 3D visual effect would be generated owing to binocular disparity between the left image and the right image.

However, before displaying the converted left and right images which is sent to the display device 11, the video content would be performed various image processing by the image processor 111 embedded in the display device 11. It will introduce a finite delay which is usually caused by the video processing delay of the display device 11. The introduction of this delay causes out-of-sync between the switch-on and switch-off of the pair of shutter glasses 15 and the display device's 11 playback of the right and left images. As a result, the viewer's 3D impression will be adversely impacted.

For the reason that conventional 2D-to-3D imaging system could not effectively display 3D image or video owing to the video processing delay, a need has arisen to propose a novel delay compensation system and method to compensate the video processing delay and improve 3D visual effect.

### SUMMARY OF THE INVENTION

In view of the foregoing, it is an object of the embodiment of the present invention to provide a 2D-to-3D delay compensation system and method thereof to compensate the video processing delay caused by the display device to perform image processing for the right and left images.

According to one embodiment, a 2D-to-3D delay compensation system tied in with a display device comprises a 2D-to-3D conversion box and a pair of shutter glasses. The 2D-to-3D conversion box is coupled with the display device and sends out at least a calibration pattern to the display device to display. When sending each calibration pattern, the 2D-to-3D conversion box sends out a shutter control signal after waiting a delay time. The pair of shutter glasses which comprises a left (L) lens and a right (R) lens receives the shutter control signal to switch on and off its left and right lenses. The pair of shutter glasses further comprises a detection unit which is configured to detect the calibration pattern and then send out an adjustment signal to the 2D-to-3D conversion box. Wherein, when the calibration pattern detected by the detection unit is substantially complete, the detection unit will send out a synchronization signal to the 2D-to-3D conversion box. The 2D-to-3D conversion box adaptively adjusts the delay time after receiving the adjustment signal until the synchronization signal is received.

According to another embodiment, a 2D-to-3D delay compensation method for making a pair of shutter glasses be synchronization with a display device's playback of a video source is disclosed. The display device is coupled with a 2D-to-3D conversion box. The method includes the following steps: firstly, the 2D-to-3D conversion box sends out a calibration pattern to the display device. Then, a shutter control signal is sent out after waiting a delay time to switch on and off the pair of shutter glasses' left and right lenses. Subsequently, the calibration pattern is detected. Finally, determine whether the delay time must be adjusted or not according to the detecting result. Accordingly, the shutter control signal may be sent out after waiting the adjusted delay time to adaptively switch on and off its lenses to be synchronization with the video source.

### BRIEF DESCRIPTION OF THE DRAWINGS

FIG. 1 shows a block diagram of a conventional 2D-to-3D imaging system;

FIG. 2 shows a block diagram illustrating a 2D-to-3D delay compensation system according to one embodiment of the present invention;

FIG. 3 shows a circuit diagram illustrating a detection unit according to one embodiment of the present invention; and

FIG. 4 shows a flow diagram illustrating a 2D-to-3D delay compensation method according to one embodiment of the present invention.

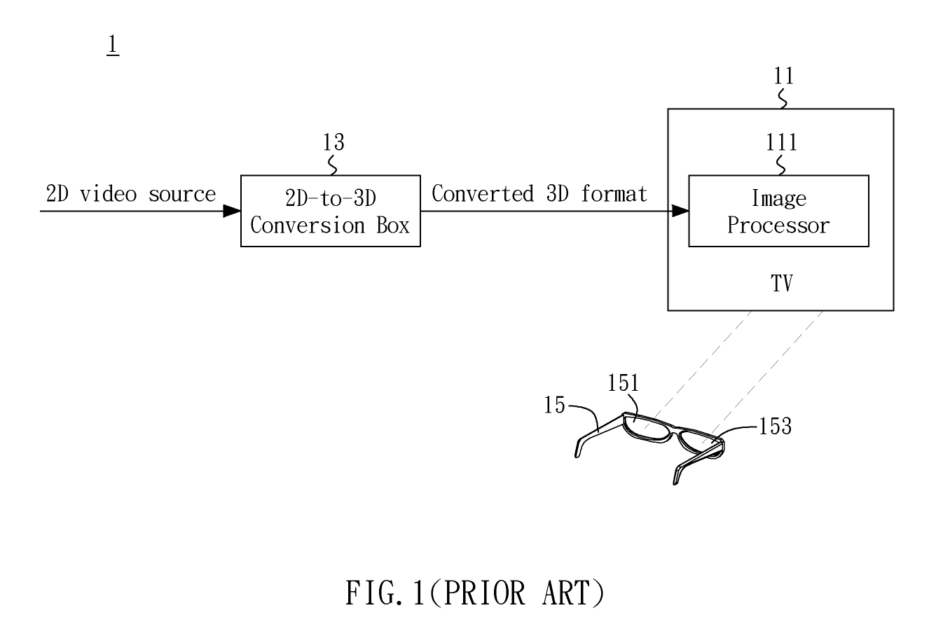

### DETAILED DESCRIPTION OF THE INVENTION

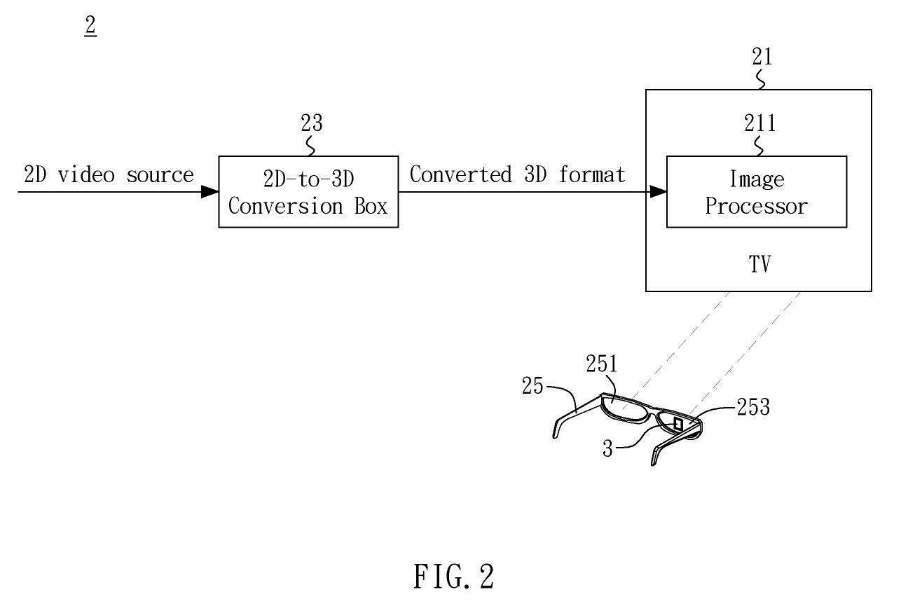

FIG. 2 is a block diagram illustrating a 2D-to-3D delay compensation system according to one embodiment of the present invention. The 2D-to-3D delay compensation system 2, as shown in FIG. 2, comprising a 2D-to-3D conversion box 23 and a pair of 2D-to-3D shutter glasses 25, is tied in with a display device 21. The 2D-to-3D conversion box 23 is connected with the display device 21, and is configured to convert an input 2D video source to a converted 3D output format. The converted 3D output format frame then may be transmitted to the display device 21 to display. Specifically, the 2D video source includes a series of frames. It may be implemented by the Depth-Image-Based Rendering (DIBR) technique in the 2D-to-3D conversion box 23 to calculate the binocular disparity of each frame of the original 2D video source, and further generate (or synthesize) a left (L) image and a right (R) image to be displayed by the display device 21 in sequence.

The pair of shutter glasses 25 comprises a left (L) lens 251 and a right (R) lens 253. When the 2D-to-3D conversion box 23 outputs the left and right images, it may send out a shutter control signal to the pair of shutter glasses 25 for the pair of shutter glasses 25 to switch on and off its right and left lens 253, 251, which further controls the left and right images to only pass through the left and right lenses, 251 and 253, respectively. For example, the 2D-to-3D conversion box 23 converts the input 2D video source, e.g. 60 Hz progressive, to a converted 3D output format, e.g. 120 Hz with left and right-eye frame each 60 Hz in the shutter glasses application.

The display device 21 comprises an image processor 211 which is configured to perform various image processing, such as luminance, color or contrast adjustment, for the converted left and right images, and then displays the processed left and right images to be received by the left and right lenses, 251 and 253, respectively. In one embodiment, the display device 21 may be, but is not limited to, a Plasma Display Panel (PDP), Plasma TV, Liquid Crystal Display (LCD) TV, or Cathode Ray Tube (CRT) TV.

The 2D-to-3D conversion box 23 pre-stores tailor-made special calibration patterns, in one embodiment, the calibration pattern can be, but is not limited to, a completely black pattern, for example, a completely black frame, or a completely white pattern, for example, a completely white frame. Before converting the 2D video source, the 2D-to-3D conversion box 23 sends out the calibration pattern to the display device 21, and estimates the time that the pair of shutter glasses 25 receives the processed calibration pattern from the image processor 211 to control the lenses to adaptively switch on and off to be synchronization with the calibration pattern.

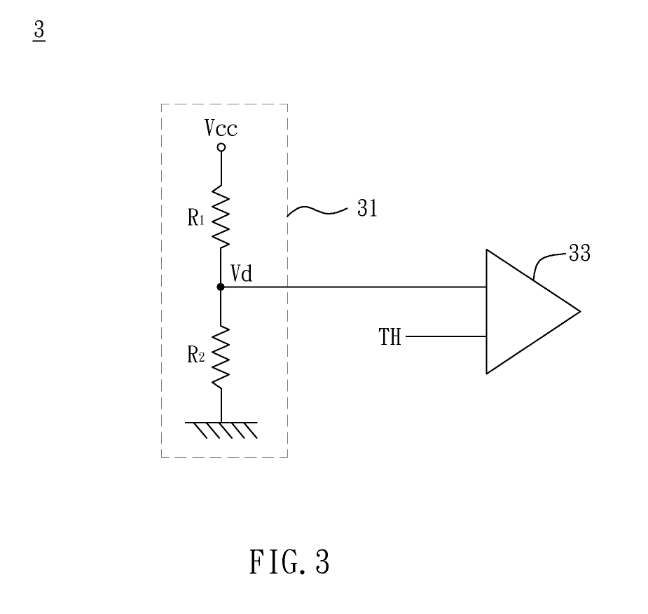

The pair of shutter glasses 25 further comprises a detection unit 3 which is configured to detect the calibration pattern. FIG. 3 is a circuit diagram illustrating a detection unit 3 according to one embodiment of the present invention. The detection unit 3 is configured behind the left and/or right lens 251, 253 of the pair of shutter glasses 25. As shown in FIG. 3, the detection unit 3 comprises a voltage divider circuit 31 and a comparator 33. The voltage divider circuit 31 has a photo-sensitive resistor R2, and the resistance value of the photo-sensitive resistor R2 varies according to the brightness of the calibration pattern. For example, the brighter the calibration pattern is, the smaller resistance value the photo-sensitive resistor R2 has, and the darker the calibration pattern is, the bigger resistance value the photo-sensitive resistor R2 has. The comparator 33, which is coupled to the divider circuit 31, is configured to compare the voltage-divided value Vd outputted from the voltage divider circuit 31 with a threshold TH. Whether the delay time must be adjusted is determined based on the above comparing result. Wherein, the threshold TH can be set in accordance with practical applications, for example, the threshold TH is set to be a little smaller than the voltage value Vcc.

Take that the calibration pattern is a completely black pattern and the detection unit 3 is installed behind the right lens 253 as example, when the 2D-to-3D conversion box 23 transmits the completely black calibration pattern to the display device 21, the shutter control signal is sent out after waiting a delay time to switch off the shutter glasses' left lens. After the delay time, the completely black calibration pattern processed by the image processor 211 only passes through the right lens 253. The photo-sensitive resistor R2 in the right lens 253 determines the voltage-divided value Vd according to the brightness of the calibration pattern detected. If the right lens 253 receives a complete black frame, the resistance value of the photo-sensitive resistor R2 should become large to make the output of the voltage divider circuit 31 (e.g. voltage-divided value Vd) reach its maximum, e.g. Vcc. Then the comparator 33 compares the voltage-divided value Vd with the threshold TH. In the present embodiment, if the voltage-divided value Vd is larger than the threshold TH, it indicates that the right lens 253 receives a completely or substantially completely black calibration pattern, the pair of shutter glasses 25 will send out a synchronization signal to the 2D-to-3D conversion box 23. In this case, the present delay time just equals or substantially equals the time that the image processor 211 processes the calibration pattern to make the right lens 253 receive the calibration pattern synchronously.

On the contrary, if the voltage-divided value Vd is less than the threshold TH, it indicates that the time of processing the calibration pattern by the image processor 211 may be less or more than the delay time set, the pair of shutter glasses 25 will output a adjustment signal to the 2D-to-3D conversion box 23 due to the reason that it cannot receive the completely black calibration pattern exactly. The 2D-to-3D conversion box 23 adaptively adjusts the delay time after receiving the adjustment signal until the synchronization signal is received.

Similarly, the calibration pattern can be a completely white pattern, the detection unit 3 can be installed behind the left lens 251, and the photo-sensitive resistor R2 can be set in the position of resistor R1. The operation rule of the comparator 33 can be adaptively set in accordance with the circuit design. For example, if the voltage-divided value Vd is less than the threshold TH, the synchronization signal is outputted, or the adjustment signal is outputted. In one specific embodiment, the 2D-to-3D conversion box 23 sends out continuous but separated completely black patterns and completely white patterns. When sending each calibration pattern, the shutter control signal is sent out after waiting the delay time to switch on and off the left and right lenses 251, 253 until the synchronization signal is received. It indicates that the above case is completely black for the left-eye frame and completely white for the right-eye frame synchronously, respectively.

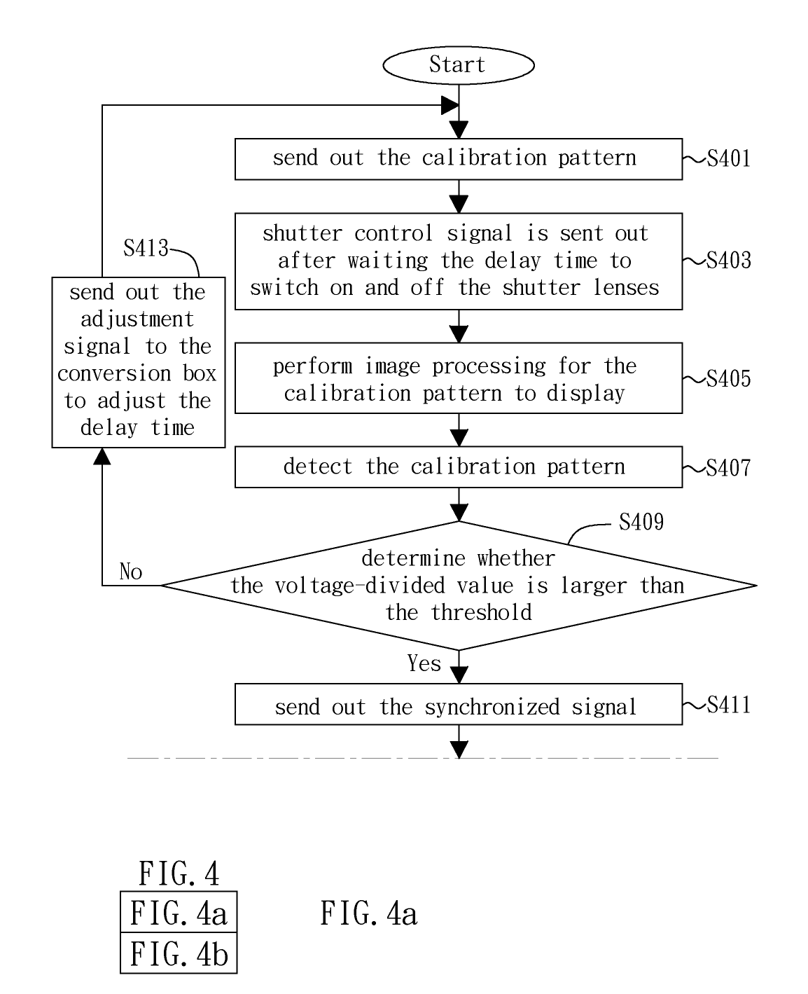

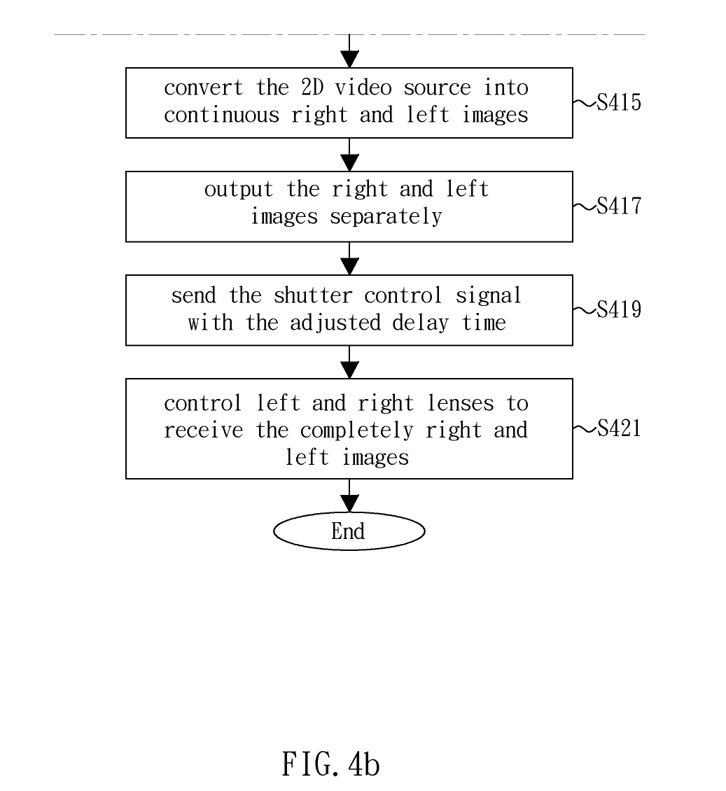

Please refer to FIG. 4, which shows a flow diagram illustrating a 2D-to-3D delay compensation method according to one embodiment of the present invention. It still takes that the calibration pattern is a completely black pattern and the detection unit 3 is installed behind the right lens 253 as example. The method comprises the following steps:

When first-time use of this setup or every time a new display device is used, the 2D-to-3D delay compensation system 2 needs to be initialized with a calibration phase to ensure quality 3D viewing experience. Firstly, in step S401, the 2D-to-3D conversion box 23 sends out the pre-stored calibration pattern to the display device 21, and the shutter control signal is sent out after waiting the default delay time to switch on and off the left and right lenses 251, 253 of the pair of shutter glasses 25 in step S403. After receiving the calibration pattern, the display device 21 performs image processing for it to display in step S405.

Sequentially, in step S407, the detection unit 3 configured behind the right lens 253 detects the calibration pattern processed by the display device 21. The voltage-divided value Vd is then generated according to the brightness of the calibration pattern. In step S409, whether the voltage-divided value Vd is larger than the default threshold TH is determined. If yes, it indicates that the time that the image processor 211 performs image processing equals or substantially equals the present delay time, and make the right lens 253 receive a completely black calibration pattern to achieve synchronization. Therefore, in step S411, the pair of shutter glasses 25 sends out the synchronization signal to the 2D-to-3D conversion box 23.

If the voltage-divided value Vd is not larger than the default threshold TH, it indicates that the right lens 253 is switched on, which is controlled by the shutter control signal too early or too late, the processed calibration pattern cannot pass through the right lens 253 synchronously. Therefore, in step S413, the pair of shutter glasses 25 sends out the adjustment signal to the 2D-to-3D conversion box 23 to adjust the delay time. The 2D-to-3D conversion box 23 adaptively adjusts the delay time and repeats the step S401-S409 after receiving the adjustment signal until the synchronization signal is received.

In a specific embodiment of the present invention, the calibration pattern is sent out periodically and separately in the step S401, for example, a completely white calibration pattern follows a completely black calibration pattern, and so on. The calibration pattern is outputted continuously, and the switch-on and switch-off of the left and right lenses 251, 253 should be in synchronization with the display device's 21 playback of the completely white calibration pattern and the completely black calibration pattern respectively.

After finishing the above initialized process, the viewer can wear the pair of shutter glasses 25 and input the 2D video source to the 2D-to-3D conversion box 23 to convert it into continuous right images and left images in step S415. Then, the 2D-to-3D conversion box 23 outputs the right and left images separately to the display device 21 in step S417 and sends the shutter control signal with the adjusted delay time in step S419. That is, when transmitting each image (right or left image), the shutter control signal is sent out after waiting the delay time which can compensate image processing delay. Therefore, the left and right lenses 251, 253 can be controlled to receive the completely right and left images by time-division to achieve synchronization.

Although specific embodiments have been illustrated and described, it will be appreciated by those skilled in the art that various modifications may be made without departing from the scope of the present invention, which is intended to be limited solely by the appended claims.

What is claimed is:

1. A 2D-to-3D delay compensation system tied in with a display device, comprising:
a 2D-to-3D conversion box coupled with the display device, the 2D-to-3D conversion box being configured to send out at least a calibration pattern to the display device to display, and send out a shutter control signal after waiting a delay time when transmitting each and all of said calibration pattern; and
a pair of shutter glasses comprising:
a left lens and a right lens, wherein the pair of shutter glasses is configured to receive the shutter control signal to switch on and off its left and right lenses; and
a detection unit, configured to detect the calibration pattern and then send out an adjustment signal to the 2D-to-3D conversion box;
wherein, when the calibration pattern is detected complete, the detection unit is configured to send out a synchronization signal to the 2D-to-3D conversion box, and after receiving the adjustment signal, the 2D-to-3D conversion box is configured to adaptively adjust the delay time until the synchronization signal is received.

2. The system of claim 1, wherein the shutter control signal controls to switch off one of the lens and switch on the other lens to receive the calibration pattern.

3. The system of claim 2, wherein the detection unit comprises:
a voltage divider circuit having a photo-sensitive resistor, which varies its resistance value according to the brightness of the calibration pattern displayed by the display device, and then generates a voltage-divided value; and
a comparator coupled to the divider circuit, the comparator being configured for comparing the voltage-divided value with a threshold;
wherein, if the voltage-divided value is larger than the threshold, the synchronization signal is sent out, or the adjustment signal is sent out.

4. The system of claim 3, wherein the detection unit is installed behind the left lens or the right lens for receiving the calibration pattern, wherein the calibration pattern comprises a completely black pattern or a completely white pattern.

5. The system of claim 2, wherein the detection unit comprises:
a voltage divider circuit having a photo-sensitive resistor, which varies its resistance value according to the brightness of the calibration pattern displayed by the display device, and then generates a voltage-divided value; and
a comparator coupled to the divider circuit, the comparator being configured for comparing the voltage-divided value with a threshold;
wherein, if the voltage-divided value is less than the threshold, the synchronization signal is sent out, or the adjustment signal is sent out.

6. The system of claim 5, wherein the detection unit is installed behind the left lens or the right lens for receiving the calibration pattern, wherein the calibration pattern comprises a completely black pattern or a completely white pattern.

7. The system of claim 1, wherein the display device comprises a Plasma Display Panel (PDP), Plasma TV, Liquid Crystal Display (LCD) TV, or Cathode Ray Tube (CRT) TV.

8. A 2D-to-3D delay compensation method for making a pair of shutter glasses be synchronization with a display device's playback of a video source, the display device is coupled with a 2D-to-3D conversion box, and the method comprising:
sending out at least one calibration pattern to the display device by the 2D-to-3D conversion box;
sending out a shutter control signal after waiting a delay time to switch on and off a left lens and a right lens of the pair of shutter glasses;
detecting the calibration pattern; and
determining whether the delay time must be adjusted or not according to the detecting result;
accordingly, the shutter control signal will be sent out after waiting the adjusted delay time to adaptively switch on and off its lenses to be synchronization with the video source.

9. The method of claim 8, wherein the step of detecting the calibration pattern comprises:
providing a voltage divider circuit in the pair of shutter glasses, the voltage divider circuit having a photo-sensitive resistor which varies its resistance value according to the brightness of the calibration pattern displayed by the display device, and then generates a voltage-divided value; and
comparing the voltage-divided value with a threshold.

10. The method of claim 9, wherein the step of determining whether the delay time must be adjusted or not comprises:
determining if the voltage-divided value is larger than the threshold, a synchronization signal being sent out by the pair of shutter glasses; and
determining if the voltage-divided value is less than the threshold, an adjustment signal being sent out to the 2D-to-3D conversion box to adjust the delay time;
wherein, the 2D-to-3D conversion box sends out the calibration pattern periodically to adjust the delay time until the synchronization signal is received.

11. The method of claim 9, wherein the step of determining whether the delay time must be adjusted or not comprises:
determining if the voltage-divided value is less than the threshold, a synchronization signal being sent out by the pair of shutter glasses; and
determining if the voltage-divided value is larger than the threshold, an adjustment signal being sent out to the 2D-to-3D conversion box to adjust the delay time;
wherein, the 2D-to-3D conversion box sends out the calibration pattern periodically to adjust the delay time until the synchronization signal is received.

12. The method of claim 10, wherein the voltage divider circuit is installed behind the left lens or the right lens for detecting the calibration pattern, wherein the calibration pattern comprises a completely black pattern or a completely white pattern.

13. The method of claim 11, wherein the voltage divider circuit is installed behind the left lens or the right lens for detecting the calibration pattern, wherein the calibration pattern comprises a completely black pattern or a completely white pattern.

14. The method of claim 8, wherein the video source is two-dimensional (2D), and the method further comprises:
converting the video source into a plurality of continuous right images and a plurality of continuous left images;
outputting the right and left images separately;
sending the shutter control signal with the adjusted delay time; and
controlling the right and left lenses to receive the completely right and left images by time-division to achieve synchronization.

15. The method of claim 8, wherein the display device comprises a Plasma Display Panel (PDP), Plasma TV, Liquid Crystal Display (LCD) TV, or Cathode Ray Tube (CRT) TV.
